(19) United States
(12) Patent Application Publication
(10) Pub. No.: US 2022/0412291 A1
(43) Pub. Date: Dec. 29, 2022

(54) ANTI-BACK-TRANSFER INTAKE STRUCTURE FOR ROTATING DETONATION COMBUSTION CHAMBER

(71) Applicant: PLA AIR FORCE ENGINEERING UNIVERSIT, Xi’an (CN)

(72) Inventors: Feilong SONG, Xi’an (CN); Yun WU, Xi’an (CN); Huimin SONG, Xi’an (CN); Min JIA, Xi’an (CN); Shanguang GUO, Xi’an (CN); Xin CHEN, Xi’an (CN); Di JIN, Xi’an (CN); Zhao YANG, Xi’an (CN)

(21) Appl. No.: 17/848,036

(22) Filed: Jun. 23, 2022

(30) Foreign Application Priority Data
Jun. 26, 2021 (CN) 202110715244.8

(51) Int. Cl. F02K 7/08; F02C 3/14; F02C 7/00

(52) U.S. Cl. CPC F02K 7/08; F02C 3/14; F02C 7/00

(57) ABSTRACT

The application relates to an anti-back-transfer intake structure of a rotating detonation combustion chamber including a Tesla valve communicating with the rotating detonation combustion chamber and arranged at an inlet of the rotating detonation combustion chamber. The Tesla valve includes a casing and a flow passage, the casing is coaxially connected with an outer wall of the rotating detonation combustion chamber, the flow passage is arranged in the casing, and the flow passage has an inlet end for introducing air, and an outlet end connected with an annular passage of the rotating detonation combustion chamber.

### CROSS-REFERENCE TO RELATED APPLICATION

The present application is based on and claims the priority benefits of China application No. 202110715244.8, filed on Jun. 26, 2021. The entirety of China application No. 202110715244.8 is hereby incorporated by reference herein and made a part of this specification.

### TECHNICAL FIELD

The application relates to the field of aeroengines, and in particular, to an anti-back-transfer intake structure for a rotating detonation combustion chamber.

### BACKGROUND ART

Detonation combustion is realized by compressing the explosive mixture with the leading fundamental wave to produce a high-speed chemical reaction. Because detonation combustion has the advantages of high heat release intensity per unit time, self pressurization, high combustion efficiency and low pollutant emission, the propulsion technology based on detonation combustion is an important development trend of space technology in the future. A rotating detonation combustion chamber is an annular combustion chamber using detonation combustion. The fuel is supplied by multiple nozzles at the head of the combustion chamber.

As shown in FIG. 1, in an related technology, an intake structure for a rotating detonation combustion chamber includes an air inlet end 2 communicating with the combustion chamber body 1 and arranged at the inlet of the combustion chamber body 1. The air inlet end 2 includes a coaxially sleeved inner wall 21 and an outer wall 22. Between the inner wall 21 and the outer wall 22, there is an air inlet passage 23 for fuel and air to enter the combustion chamber body 1. The air inlet passage 23 includes a straight passage 231 and an enlarged passage 232. One end of the straight passage 231 is connected with an air inlet end, the other end is connected with the gradually enlarged passage 232, and the other end of the enlarged passage 232 is connected with the combustion chamber body 1. Therefore, a converging-enlarging inlet structure is formed.

In the above related technology, it is found that there is back transfer of pressure in the existing rotating detonation combustion chamber, resulting in large total pressure loss in the combustion chamber.

### SUMMARY

In view of the above, the application provides an anti-back-transfer intake structure for a rotating detonation combustion chamber, which adopts the following technical solution: an anti-back-transfer intake structure for a rotating detonation combustion chamber including a Tesla valve communicating with the rotating detonation combustion chamber and arranged at an inlet of the rotating detonation combustion chamber. The Tesla valve includes a casing and a flow passage, the casing is coaxially connected with an outer wall of the rotating detonation combustion chamber, and the flow passage is arranged in the casing. The flow passage has an inlet end configured for introducing air, and an outlet end communicating with an annular passage of the rotating detonation combustion chamber.

In the above technical solution, by using the one-way flow characteristics of the Tesla valve, a forward passage for guiding air and fuel into the rotating detonation combustion chamber is separated from a backward passage for back-transferring pressure and combustion product, so as to effectively reduce the possibility of back-transferred pressure and combustion product blocking air and fuel, so that the detonation pressurization can make up for the total pressure loss due to air intake. Thus, the total pressure gain of the rotating detonation combustion chamber is improved, and the high temperature returned by the combustion products is avoided to ignite the reactants in advance, so as to reduce the influence of the back transferring of the combustion products on the performance of the rotating detonation combustion chamber. Further, the Tesla valve can realize the one-way flow of air flow without any moving parts and input energy. There is a large difference between a forward flow and a reverse flow, and thus there is no need for internal mechanical movement. It uses merely a spatial structure to promote the gas flow and a physical structure to accelerate the gas.

Optionally, the flow passage comprises an air inlet passage, a connecting passage, an arc-shaped returning passage and an enlarged passage. One end of the air inlet passage is used to feed air, and the other end communicates with the connecting passage. The arc-shaped returning passage includes an arc-shaped passage and a straight passage. The straight passage is provided in linear communication with the connecting passage. The arc-shaped passage is configured to connect the straight passage to the air inlet passage. An included angle between the air inlet passage and the straight passage is an acute angle, and the enlarged passage is in linear communication with the connecting passage. A smaller end of the enlarged passage communicates with an end of the connecting passage away from the air inlet passage, and an larger end of the enlarged passage communicates with the annular passage of the rotating detonation combustion chamber.

In the above technical solution, when air and fuel enter the annular passage of the rotating detonation combustion chamber in a forward direction, the air and fuel enter the rotating detonation combustion chamber via the inlet passage, the connecting passage and the enlarged passage in turn. When a pressure wave and/or a combustion product generated in the rotating detonation combustion chamber are transferred backward, the pressure wave and/or combustion product pass through the enlarged passage, the connecting passage, the straight passage and the arc-shaped passage in turn. The straight passage and the arc-shaped passage form an arc-shaped returning passage. The pressure wave and/or combustion products are transferred backward through the arc-shaped returning passage, and are weakened by the arc-shaped returning passage. Since the returning passage of the pressure wave and combustion products and the forward inlet passage of air and fuel are different passages, returning pressure wave and/or combustion products have little impact on forward feeding of the air and fuel, so as to reduce the total inlet pressure loss, and increase the total pressure gain of the rotating detonation combustion chamber.

Optionally, the included angle between the air inlet passage and the straight passage is 30°-45°.

In the above technical solution, when the included angle between the air inlet passage and the straight passage is 30°-45°, the reverse blocking performance of Tesla valve is improved with the increase of the included angle.

Optionally, the casing comprises a first connecting cylinder, a second connecting cylinder and a guide block, the first connecting cylinder is coaxially sleeved with the second connecting cylinder, and the guide block is coaxially arranged between the first connecting cylinder and the second connecting cylinder. The first connecting cylinder includes a first connecting section, a second connecting section and a third connecting section connected in sequence, the second connecting cylinder includes a fourth connecting section, a fifth connecting section and a sixth connecting section connected in sequence, and the guide block includes a first straight guide surface, an arc-shaped guide surface and a second straight guide surface connected in sequence. One end of the first straight guide surface away from the arc-shaped guide surface is connected with one end of the second straight guide surface away from the arc-shaped guide surface. The second connecting section is parallel to the fifth connecting section. The connecting passage is positioned between the second connecting section and the fifth connecting section, the first connecting section and the third connecting section are positioned at both ends of the second connecting section and inclined towards a side away from the fifth connecting section. The sixth connecting section is symmetrical to the third connecting section, the enlarged passage is positioned between the third connecting section and the sixth connecting section, the fourth connecting section is arranged on a side of the fifth connecting section close to the first connecting section and at an end of the fifth connecting section away from the sixth connecting section, and the air inlet passage is positioned between the first connecting section and the first straight guide surface. The arc-shaped passage is positioned between the fourth connecting section and the arc-shaped guide surface, and the straight passage is positioned between the second straight guide surface and the fifth connecting section.

In the above technical solution, the first connecting section, the second connecting section and the third connecting section form a first connecting cylinder, the fourth connecting section, the fifth connecting section and the sixth connecting section form a second connecting cylinder, and the first straight guide surface, the arc-shaped guide surface and the second straight guide surface form the guide block, so as to form a flow passage, which has simple structure and is convenient for mass production.

Optionally, a casing is arranged on one side of the first connecting cylinder away from the second connecting cylinder, a containing cavity for containing fuel is formed between the casing and the first connecting cylinder, and a plurality of fuel ejection holes are arranged between the containing cavity and the air inlet passage.

In the above technical solution, the fuel is loaded in the containing cavity, and the fuel in the containing cavity is injected into the air inlet passage through the fuel ejection hole.

Optionally, the fuel ejection holes are circumferentially provided on the first connecting section at intervals and positioned on a side of the first connecting section close to the second connecting section.

In the above technical solution, the fuel ejected from the fuel ejection hole enters the second connecting section with the air, and the incoming air provides power for the flow of fuel.

Alternatively, a plurality of first connecting columns are arranged circumferentially on one side of the first straight guide surface close to the first connecting section, the other end of the first connecting column is connected with the first connecting section, a plurality of second connecting columns are arranged circumferentially on one side of the second straight guide surface close to the fifth connecting section, and the second connecting column is connected with the fifth connecting section.

In the above technical solution, the connection between the first connecting section and the first straight guide surface is realized through the first connecting column, and the connection between the fifth connecting section and the second straight guide surface is realized through the second connecting column, which is convenient for connecting and fixing the diversion block.

In summary, the present application can achieve at least one of the following beneficial technical effects.

1. By using the one-way flow characteristics of the Tesla valve, a forward passage for guiding air and fuel into the rotating detonation combustion chamber is separated from a backward passage for back-transferring pressure and combustion product, so as to effectively reduce the possibility of back-transferred pressure and combustion product blocking air and fuel, so that the detonation pressurization can make up for the total pressure loss due to air intaking. Thus, the total pressure gain of the rotating detonation combustion chamber is improved, and the high temperature returned by the combustion products is avoided to ignite the reactants in advance, so as to reduce the influence of the back transferring of the combustion products on the performance of the rotating detonation combustion chamber.

2. The use of the Tesla valve without moving parts can realize the one-way flow of air flow without any moving parts and input energy. There is a large difference between a forward flow and a reverse flow, and thus there is no need for internal mechanical movement. It uses merely a spatial structure to promote the gas flow and a physical structure to accelerate the gas;

3. When air and fuel enters the annular passage of the rotating detonation combustion chamber in a forward direction, the air and fuel enters the rotating detonation combustion chamber via the inlet passage, the connecting passage and the enlarged passage in turn. When a pressure wave and/or a combustion product generated in the rotating detonation combustion chamber are transferred backward, the pressure wave and/or combustion product pass through the enlarged passage, the connecting passage, the straight passage and the arc-shaped passage in turn. The straight passage and the arc-shaped passage form an arc-shaped returning passage. The pressure wave and/or combustion products are transferred backward through the arc-shaped returning passage, and are weakened by the arc-shaped returning passage. Since the returning passage of the pressure wave and combustion products and the forward inlet passage of air and fuel are different passages, returning pressure wave and/or combustion products have little impact on forward feeding of the air and fuel, so as to reduce the total inlet pressure loss, and increase the total pressure gain of the rotating detonation combustion chamber.

### BRIEF DESCRIPTION OF THE DRAWINGS

FIG. 1 is a cross-sectional view of an intake structure of a rotating detonation combustion chamber in the related technology in use state;

FIG. 2 is a cross-sectional view of an anti-back-transfer intake structure of the rotating detonation combustion chamber according to Embodiment 1 of the present application in use state;

FIG. 3 is a partial structural diagram of FIG. 2;

FIG. 4 is a schematic diagram of the overall structure of a Tesla valve in FIG. 2;

FIG. 5 is a perspective sectional view of FIG. 4;

FIG. 6 is a partial structural diagram of FIG. 5;

FIG. 7 is an exploded view of FIG. 4 along an axial direction;

FIG. 8 is a cross-sectional view of an anti-back-transfer intake structure of a rotating detonation combustion chamber according to Embodiment 2 of the present application in use state; and

FIG. 9 is a partial structural diagram of FIG. 8.

### DETAILED DESCRIPTION

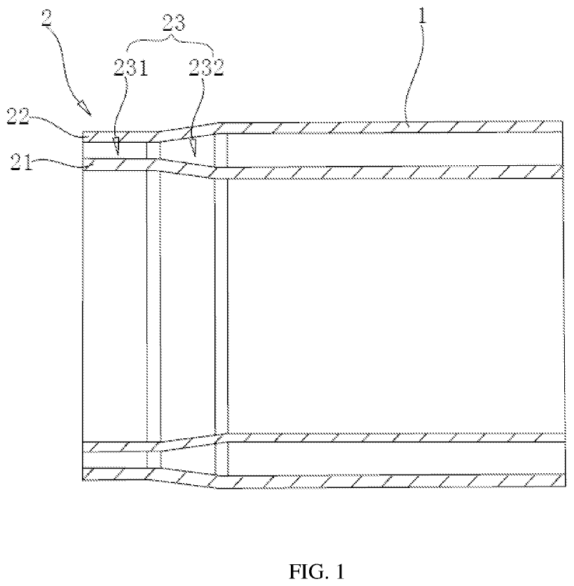

The present application will be further described in detail below in combination with FIGS. 1-9.

As shown in FIG. 1, an intake structure for a rotating detonation combustion chamber in the related technology includes an air inlet end 2 communicating with a combustion chamber body 1 and fixedly assembled at an inlet of the combustion chamber body 1. The air inlet end 2 includes coaxially sleeved inner wall 21 and an outer wall 22. Between the inner wall 21 and the outer wall 22, there is an air inlet passage 23 for fuel and air to enter the combustion chamber body 1. The air inlet passage 23 includes a connected straight passage 231 and an enlarged passage 232. One end of the straight passage 231 is connected with the outside air, the other end is connected with the enlarged passage 232, and the other end of the enlarged passage 232 is connected with the combustion chamber body 1. Therefore, a converging-enlarging inlet structure is formed.

Detonation wave is a chemical reaction zone caused by a shock wave, which rotates at a high speed around the combustion chamber body. The pressure at the location where the detonation wave is positioned is very high. Every time the detonation wave turns to a position, it will induce back transferring of a pressure, which will lead to the air inlet blockage of the air inlet end 2. After the blockage, the pressure attenuation is relatively slow, resulting in a long recovery time of the air inlet. When the detonation wave turns back to the original position again, fresh air and the fuel required for the reaction cannot be replenished into the combustion chamber body 1 in time, resulting in the extinction of the detonation wave.

The converging-enlarging intake scheme is essentially a supersonic intake scheme. A forward shock wave will be formed in the enlarged passage 232. This forward shock wave can block the pressure return of the detonation wave, and the Mach number of supersonic intake is very high, which can quickly supplement fresh air and fuel required for reaction. This solves the problem of slow intake recovery time, but the total pressure loss of the engine before and after the forward shock wave is large, and the rotary detonation wave cannot make up for the total pressure loss, resulting in a backward total pressure gain of a whole engine.

The combustion product is high-temperature exhaust gas that has been combusted. When the high-temperature exhaust gas in the combustion chamber body 1 is accumulated upstream of the air inlet passage 23, the reactants that would have been subject to detonation combustion upstream will be consumed in advance, in which the combustion mode is isobaric combustion of the conventional engine, so that the effective fuel is consumed by isobaric combustion, and pressurization cannot be realized.

The embodiments of the application disclose an anti-back-transfer intake structure for a rotating detonation combustion chamber.

### Embodiment 1

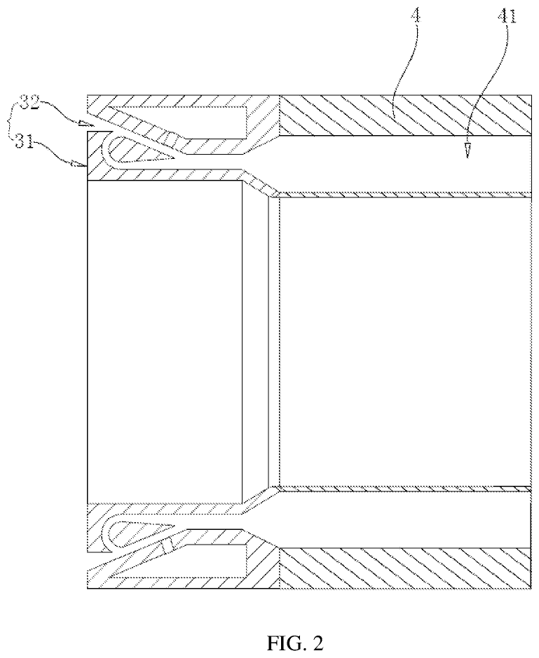

As shown in FIG. 2, an anti-back-transfer intake structure for a rotating detonation combustion chamber includes a Tesla valve 3 communicating with the rotating detonation combustion chamber 4 and snap connected in an inlet of the rotating detonation combustion chamber 4. The Tesla valve 3 includes a casing 31 and a flow passage 32. The casing 31 is coaxially snap connected with an outer wall of the rotating detonation combustion chamber 4. The flow passage 32 is opened in the casing 31. An inlet end of the flow passage 32 is used to feed air, and an outlet end of the flow passage 32 is connected with an annular passage 41 of the rotating detonation combustion chamber 4.

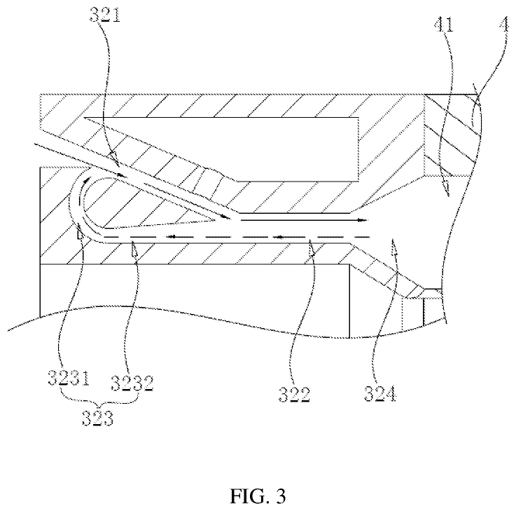

As shown in FIG. 2 and FIG. 3, the flow passage 32 includes an air inlet passage 321, a connecting passage 322, an arc-shaped returning passage 323 and an enlarged passage 324. One end of the air inlet passage 321 is configured to feed air, and the other end is connected with the connecting passage 322. The arc-shaped returning passage 323 includes an arc-shaped passage 3231 and a straight passage 3232. The straight passage 3232 is arranged in linear communication with the connecting passage 322. The arc-shaped passage 3231 is used to connect the straight passage 3232 to the air inlet passage 321. An included angle between the air inlet passage 321 and the straight passage 3232 is an acute angle, and the enlarged passage 324 is in linear communication with the connecting passage 322. A smaller end of the enlarged passage 324 is connected with an end of the connecting passage 322 away from the air inlet passage 321, and a larger end of the enlarged passage 324 is connected with the annular passage 41 of the rotating detonation combustion chamber 4.

As shown in FIG. 2 and FIG. 3, by using the one-way flow characteristics of the Tesla valve 3, a forward passage for guiding air and fuel into the rotating detonation combustion chamber is separated from a backward passage for back-transferring pressure and combustion product, so as to effectively reduce the possibility of back-transferred pressure and combustion product blocking air and fuel, so that the detonation pressurization can make up for the total pressure loss due to air intaking. Thus, the total pressure gain of the rotating detonation combustion chamber is improved, and the high temperature returned by the combustion products is avoided to ignite the reactants in advance, so as to reduce the influence of the back transferring of the combustion products on the performance of the rotating detonation combustion chamber 4.

Further, the use of the Tesla valve 3 can realize the one-way flow of air flow without any moving parts and input energy. There is a large difference between a forward flow and a reverse flow, and thus there is no need for internal mechanical movement. It uses merely a spatial structure to promote the gas flow and a physical structure to accelerate the gas.

Using the anti-back-transfer structure of the rotating detonation combustion chamber of the present application, when air and fuel enters the annular passage of the rotating detonation combustion chamber 4 in a forward direction, the air and fuel enters the rotating detonation combustion chamber 4 via the air inlet passage 321, the connecting passage 322 and the enlarged passage 324 in turn, and a pressure wave and/or a combustion product generated in the rotating detonation combustion chamber 4 pass through the enlarged passage 324, and the connecting passage 322, and are split by the arc-shaped passage 3231. when the pressure wave produced in the rotating detonation combustion chamber 4 is transferred backward through the arc-shaped returning passage, it passes through the enlarged passage 324 and the connecting passage 322, a bifurcation of the air inlet passage 321 and the straight passage 3232, the straight passage 3232 and the arc-shaped passage 3231 sequentially. The forward passage and the pressure wave returning passage of the air and fuel flow are different passages, and thus the possibility of back transferred pressure blocking the forward air and fuel can be effectively reduced, so that knock pressurization can make up for the loss of the total pressure. When the combustion products generated in the rotating detonation combustion chamber 4 are transferred backward, the combustion products are returned via the enlarged passage 324, the connecting passage 322, the straight passage 3232 and the arc-shaped passage 3231 in turn, which effectively reduces the possibility of fuel consumption due to a high temperature returned by the combustion products in advance. At the same time, the combustion products are cooled and diluted by fresh air fed through the inlet of the arc-shaped returning passage 323 and the air inlet passage 321, which reduces fuel consumption after reentering the air inlet passage 321.

As shown in FIG. 3, the included angle between the air inlet passage 321 and the straight passage 3232 is 30°-45°. With the increase of the included angle, the reverse blocking performance of Tesla valve 3 is improved, and when the included angle is 45°, the Tesla valve 3 has an optimal one-way flow performance. When the included angle is 30°-45°, the forward conduction performance of the Tesla valve 3 changes little, but when the included angle is greater than 60°, the forward conduction performance of the Tesla valve 3 is decreased sharply.

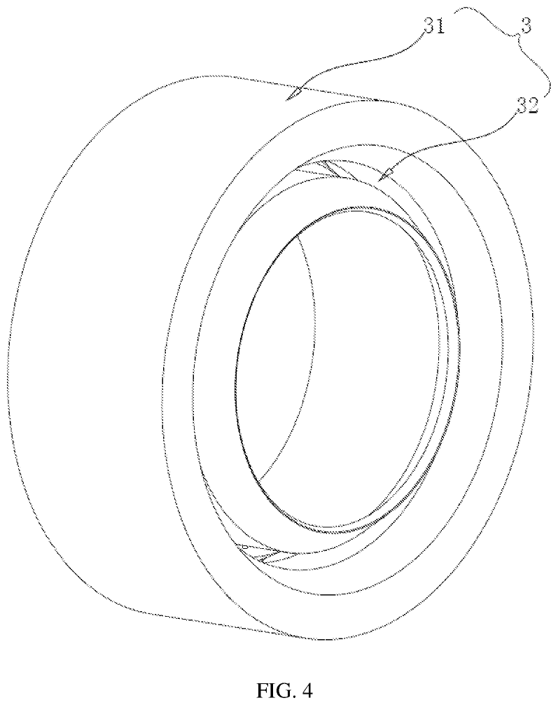

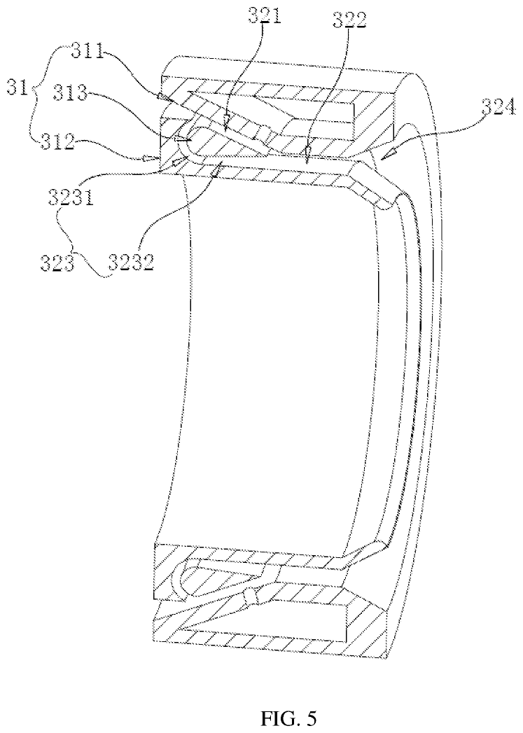

As shown in FIGS. 4 and 5, the casing 31 includes a first connecting cylinder 311, a second connecting cylinder 312 and a guide block 313. The first connecting cylinder 311 is coaxially sleeved outside the second connecting cylinder 312, and the guide block 313 is coaxially fixed between the first connecting cylinder 311 and the second connecting cylinder 312.

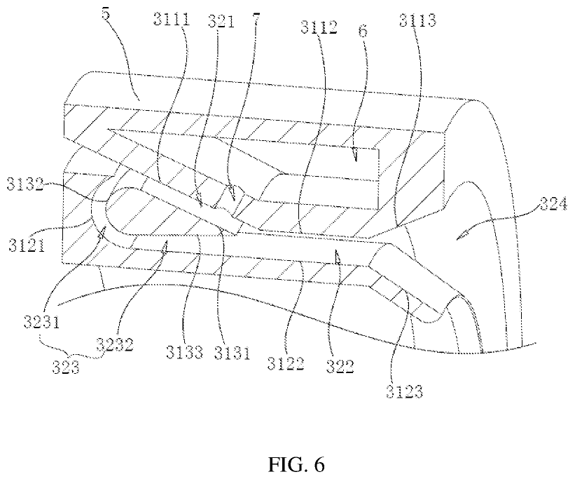

As shown in FIG. 5 and FIG. 6, the first connecting cylinder 311 includes a first connecting section 3111, a second connecting section 3112 and a third connecting section 3113 connected in sequence, and the first connecting section 3111, the second connecting section 3112 and the third connecting section 3113 are integrally formed. The second connecting cylinder 312 includes a fourth connecting section 3121, a fifth connecting section 3122 and a sixth connecting section 3123 connected in sequence, and the fourth connecting section 3121, the fifth connecting section 3122 and the sixth connecting section 3123 are integrally formed. The guide block 313 includes a first straight guide surface 3131, an arc-shaped guide surface 3132 and a second straight guide surface 3133 connected in sequence, and one end of the first straight guide surface 3131 away from the arc-shaped guide surface 3132 is connected with one end of the second straight guide surface 3133 away from the arc-shaped guide surface 3132. The second connecting section 3112 is parallel to the fifth connecting section 3122, the connecting passage 322 is positioned between the second connecting section 3112 and the fifth connecting section 3122, the first connecting section 3111 and the third connecting section 3113 are positioned at both ends of the second connecting section 3112 and inclined towards the side away from the fifth connecting section 3122, the sixth connecting section 3123 is symmetrical to the third connecting section 3113, and the enlarged passage 324 is positioned between the third connecting section 3113 and the sixth connecting section 3123. The fourth connecting section 3121 is arranged on a side of the fifth connecting section 3122 close to the first connecting section 3111 and at an end of the fifth connecting section 3122 away from the sixth connecting section 3123. The air inlet passage 321 is positioned between the first connecting section 3111 and the first straight guide surface 3131, the arc-shaped passage 3231 is positioned between the fourth connecting section 3121 and the arc-shaped guide surface 3132, and the straight passage 3232 is positioned between the second straight guide surface 3133 and the fifth connecting section 3122.

As shown in FIG. 6, a casing 5 is arranged on the side of the first connecting cylinder 311 away from the second connecting cylinder 312, and integrally formed with the first connecting cylinder 311. A containing cavity 6 for containing fuel is formed between the casing 5 and the first connecting cylinder 311, and a plurality of fuel ejection holes 7 are circumferentially arranged between the containing cavity 6 and the air inlet passage 321 at intervals. The fuel ejection holes 7 are arranged circumferentially on the first connecting section 3111 at equal intervals, and positioned on a side of the first connecting section 3111 close to the second connecting section 3112. The fuel is loaded in the containing cavity 6, and injected into the air inlet passage 321 through the fuel ejection hole 7. The fuel ejection hole 7 is closer to the connecting passage 322 than an air inlet into the air inlet passage 321, that is, the fuel ejected from the fuel ejection hole 7 enters the second connecting section 3112 with the air, and the incoming air provides power for the flow of fuel.

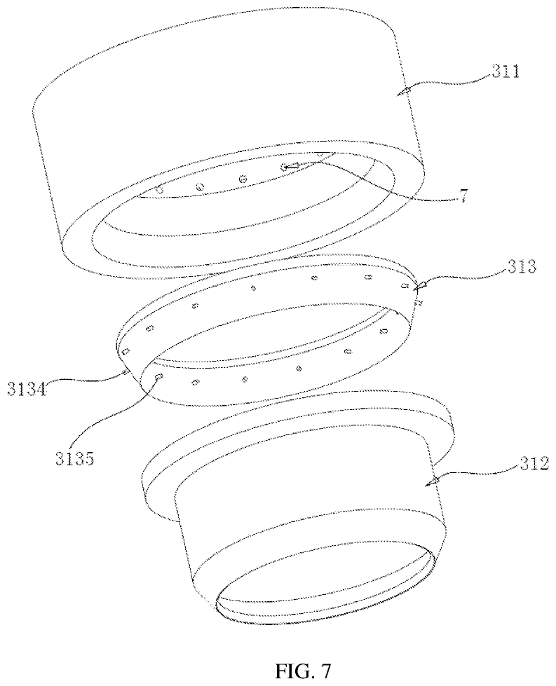

As shown in FIGS. 6 and 7, a plurality of first connecting columns 3134 are installed circumferentially at equal intervals on one side of the first straight guide surface 3131 close to the first connecting section 3111, the other end of the first connecting column 3134 is connected with the first connecting section 3111, a plurality of second connecting columns 3135 are installed circumferentially at equal intervals on one side of the second straight guide surface 3133 close to the fifth connecting section 3122, and the second connecting column 3135 is connected with the fifth connecting section 3122.

The implementation principle of Embodiment 1 of the application is as follows. When the air and fuel enter the rotating detonation combustion chamber 4 in a forward direction, the air and fuel enter the rotating detonation combustion chamber 4 via the air inlet passage 321, the connecting passage 322 and the enlarged passage 324 in turn.

When the pressure wave generated in the rotating detonation combustion chamber 4 are transferred backward, the pressure wave will pass through the enlarged passage 324 and the connecting passage 322 in turn, reach the bifurcation of the air inlet passage 321 and the straight passage 3232, and then the pressure wave will go straight through the straight passage 3232 and returned via the arc-shaped passage 3231.

When the combustion products generated in the rotating detonation combustion chamber 4 are transferred backward, the combustion products are returned through the enlarged passage 324, the connecting passage 322, the straight passage 3232 and the arc-shaped passage 3231 in turn.

### Embodiment 2

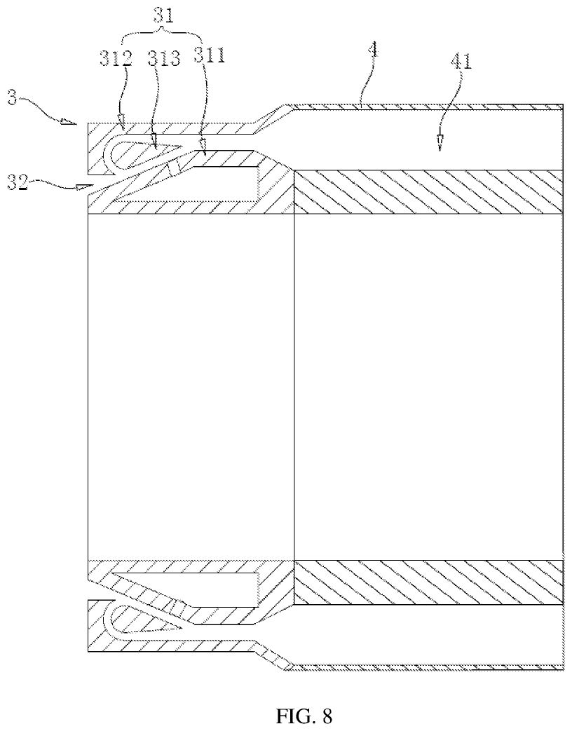

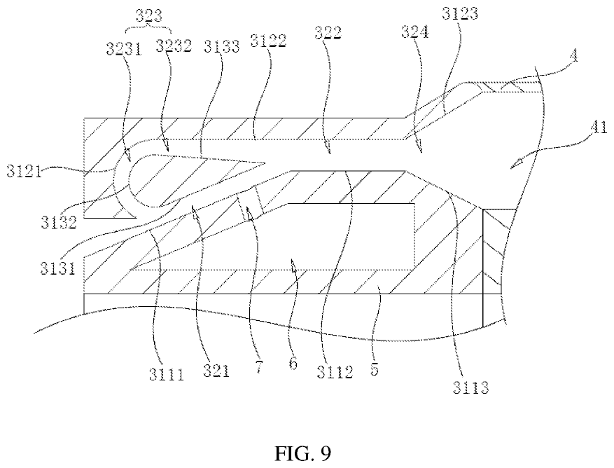

As shown in FIG. 8 and FIG. 9, the difference of this embodiment from Embodiment 1 is that, the casing 31 includes a first connecting cylinder 311, a second connecting cylinder 312 and a guide block 313. The first connecting cylinder 311 is coaxially sleeved inside the second connecting cylinder 312, and the guide block 313 is coaxially fixed between the first connecting cylinder 311 and the second connecting cylinder 312.

An implementation principle of Embodiment 2 is the same as that of Embodiment 1, which will not be repeated here.

The above are the preferred embodiments of the present application, which are not intended to limit the protection scope of the present application. Therefore, all equivalent changes made according to the structure, shape and principle of the present application should be covered within the protection scope of the present application.

What is claimed is:

1. An anti-back-transfer intake structure for a rotating detonation combustion chamber, comprising a Tesla valve communicating with the rotating detonation combustion chamber and arranged at an inlet of the rotating detonation combustion chamber, wherein the Tesla valve comprises a casing and a flow passage, the casing is coaxially connected with an outer wall of the rotating detonation combustion chamber, the flow passage is arranged in the casing, and the flow passage has an inlet end for introducing air and an outlet end connected with an annular passage of the rotating detonation combustion chamber.

2. The anti-back-transfer intake structure for a rotating detonation combustion chamber according to claim 1, wherein the flow passage comprises an air inlet passage, a connecting passage, an arc-shaped returning passage and an enlarged passage; the air inlet passage has one end for introducing air and a second end communicating with the connecting passage, the arc-shaped returning passage comprises an arc-shaped passage and a straight passage, the straight passage is arranged in linear communication with the connecting passage, and the arc-shaped passage is configured to connect the straight passage with the air inlet passage, an included angle between the air inlet passage and the straight passage is an acute angle, the enlarged passage is in linear communication with the connecting passage, a smaller end of the enlarged passage is connected with an end of the connecting passage away from the air inlet passage, and a larger end of the enlarged passage is connected with the annular passage of the rotating detonation combustion chamber.

3. The anti-back-transfer intake structure for a rotating detonation combustion chamber according to claim 2, wherein the included angle between the air inlet passage and the straight passage is 30°-45°.

4. The anti-back-transfer intake structure for a rotating detonation combustion chamber according to claim 3, wherein the casing comprises a first connecting cylinder, a second connecting cylinder and a guide block, the first connecting cylinder is coaxially sleeved with the second connecting cylinder, the guide block is coaxially arranged between the first connecting cylinder and the second connecting cylinder, the first connecting cylinder comprises a first connecting section, a second connecting section and a third connecting section connected in sequence, the second connecting cylinder comprises a fourth connecting section, a fifth connecting section and a sixth connecting section, and the guide block comprises a first straight guide surface, an arc-shaped guide surface and a second straight guide surface connected in sequence, one end of the first straight guide surface away from the arc-shaped guide surface is connected with one end of the second straight guide surface away from the arc-shaped guide surface, the second connecting section is parallel to the fifth connecting section, the connecting passage is positioned between the second connecting section and the fifth connecting section, the first connecting section and the third connecting section are positioned at both ends of the second connecting section and inclined towards a side away from the fifth connecting section, the sixth connecting section is symmetrical to the third connecting section, the enlarged passage is positioned between the third connecting section and the sixth connecting section, the fourth connecting section is arranged on one side of the fifth connecting section close to the first connecting section and positioned at one end of the fifth connecting section away from the sixth connecting section, the air inlet passage is positioned between the first connecting section and the first straight guide surface, the arc-shaped passage is positioned between the fourth connecting section and the arc-shaped guide surface, and the straight passage is positioned between the second straight guide surface and the fifth connecting section.

5. The anti-back-transfer intake structure for a rotating detonation combustion chamber according to claim 4, wherein a second casing is arranged on one side of the first connecting cylinder away from the second connecting cylinder, a containing cavity for containing fuel is formed between the second casing and the first connecting cylinder, and a plurality of fuel ejection holes are arranged between the containing cavity and the air inlet passage.

6. The anti-back-transfer intake structure for a rotating detonation combustion chamber according to claim 5, wherein the fuel ejection holes are arranged circumferentially in the first connecting section at intervals and are positioned on a side of the first connecting section close to the second connecting section.

7. The anti-back-transfer intake structure for a rotating detonation combustion chamber according to claim 4, wherein a plurality of first connecting columns are arranged circumferentially on one side of the first straight guide surface close to the first connecting section, and an end of each of the first connecting columns is connected with the first connecting section, a plurality of second connecting columns are arranged circumferentially at intervals on one side of the second straight guide surface close to the fifth connecting section, and each of the second connecting columns is connected with the fifth connecting section.
